(19) United States
(12) Patent Application Publication
(10) Pub. No.: US 2026/0281682 A1
(43) Pub. Date: Sep. 17, 2026

(54) ENHANCED UE RESPONSE TO MOBILE TERMINATED (MT) EMERGENCY CALLS

(71) Applicant: T-Mobile USA, Inc., Bellevue, WA (US)

(72) Inventors: Manikanta Kumar Teja PENUMATSHA, Redmond, WA (US); Venkata S N S PIRATLA, Renton, WA (US)

(21) Appl. No.: 19/078,270

(22) Filed: Mar. 12, 2025

(51) Int. Cl. H04W 4/90

(52) U.S. Cl. CPC H04W 4/90

(57) ABSTRACT

When a UE (e.g., cellphone) is disconnected from an emergency call (e.g., 911), the PSAP may call the UE back to finish obtaining information. This return call should also be treated as an emergency call, using the SOS APN for faster call connection and higher priority than normal phone calls. To accomplish this, the P-CSCF inserts a flag into the mobile terminated (MT) session invite, which identifies the return call as being an emergency call. The AMF recognizes this flag and inserts a flag into a paging message for the UE (if in idle mode), or a session modification message for the UE (if in connected mode). The UE then inserts a flag into a session request message when answering the call from the PSAP. The wireless network recognizes this final flag and connects the UE to the PSAP using the SOS APN.

### BACKGROUND

When a caller places an emergency call, such as a 911 call in the US or a 112 call in Europe, using a user equipment (UE) over a cellular network, the call is routed to a public safety answering point (PSAP—or public safety access point) using an SOS access point name (APN) in fifth generation (5G) cellular, or an equivalent node in a different cellular generation. An APN is a gateway that connects the UE to the internet. The SOS APN has advantages over the normal internet protocol (IP) multimedia subsystem (IMS) APN that is used for non-emergency calls, such as call setup is faster because the SOS APN relaxes some authentication requirements, the SOS APN allows emergency calls in more scenarios when there are issues with the UE's subscription, and the packet traffic of the emergency call over the SOS APN is prioritized over other IMS traffic.

However, if the UE is disconnected from the call for any reason while the staff at the PSAP still have questions, whether the call is dropped by the network or the caller accidentally hangs up, the PSAP may attempt to call the UE back. However, even though this return call is a continuation of the earlier emergency call, it will be treated as a normal phone call and use the IMS APN, rather than the SOS APN. This is because, since the return call is initiated by the caller (at the PSAP) dialing the UE's phone number rather than dialing an emergency phone number (e.g., 911 or 112), the call signaling indicates a normal priority phone call. Thus, the call back portion of an emergency-related phone call is not treated as an emergency call.

### SUMMARY

The following summary is provided to illustrate examples disclosed herein, but is not meant to limit all examples to any particular configuration or sequence of operations.

Solutions are disclosed that provide signaling enhancement for mobile terminated (MT) emergency calls. Examples receive, by a proxy node of a wireless network, an MT session invite, from an emergency call answering point, for a user equipment (UE); insert, into the MT session invite, an initial emergency call flag; and forward the MT session invite, with the initial emergency call flag, to a policy node of the wireless network.

Solutions are also disclosed that provide mobility node paging enhancement for MT emergency calls. Examples receive, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in idle mode, generate a paging message for the UE, the paging message indicating an MT call from the emergency call answering point and comprising a paging emergency call flag; and forward the paging message, with the paging emergency call flag, to a base station of the wireless network.

Solutions are also disclosed that provide for protocol data unit (PDU, or packet data unit) session modification for MT emergency calls. Examples receive, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in connected mode, generate a session modification message for the UE, the session modification message indicating an MT call from the emergency call answering point and comprising a session modification emergency call flag; and forward the session modification message, with the session modification emergency call flag, to a base station of the wireless network.

Solutions are also disclosed that provide enhancement UE response to MT emergency calls. Examples receive, by a UE, a message from a base station of a wireless network, the message from the base station indicating an MT call from an emergency call answering point and comprising a first emergency call flag; based on at least receiving the message from the base station, generate a session request message indicating the MT call and comprising a session request emergency call flag; and transmit the session request message, with the session request emergency call flag, to the base station.

### BRIEF DESCRIPTION OF THE DRAWINGS

The disclosed examples are described below with reference to the accompanying drawing figures listed below, wherein:

FIG. 1 illustrates an exemplary architecture that advantageously provides signaling, paging, and session modification enhancement for mobile terminated (MT) emergency calls;

FIG. 2 illustrates features of the signaling enhancement of the architecture of FIG. 1;

FIG. 3 illustrates a message sequence diagram of messages that may be used in examples of the architecture of FIG. 1;

FIG. 4 illustrates an exemplary MT session invite that may be used in examples of the architecture of FIG. 1;

FIG. 5 illustrates an exemplary paging message that may be used in examples of the architecture of FIG. 1;

FIG. 6 illustrates an exemplary session request message that may be used in examples of the architecture of FIG. 1;

FIG. 7 illustrates another message sequence diagram of messages that may be used in examples of the architecture of FIG. 1;

FIG. 8 illustrates an exemplary session modification message that may be used in examples of the architecture of FIG. 1;

FIG. 9 illustrates another exemplary session request message that may be used in examples of the architecture of FIG. 1;

FIGS. 10A, 10B, 10C, 11A, 11B, 11C, and 11D illustrate flowcharts of exemplary operations associated with the architecture of FIG. 1; and

FIG. 12 illustrates a block diagram of a computing device suitable for implementing various aspects of the disclosure.

Corresponding reference characters indicate corresponding parts throughout the drawings. References made throughout this disclosure. Relating to specific examples, are provided for illustrative purposes, and are not meant to limit all implementations or to be interpreted as excluding the existence of additional implementations that also incorporate the recited features.

### DETAILED DESCRIPTION

When a user equipment (UE, e.g., cellphone) is disconnected from an emergency call (e.g., 911 or 112), the emergency call answering point (e.g., public safety answering point, PSAP) may call the UE back to finish obtaining information to assist with the emergency. This return call should also be treated as an emergency call, using the SOS access point name (APN) for faster call connection and higher priority than normal phone calls that use the internet protocol (IP) multimedia subsystem (IMS) APN. To accomplish this, the proxy-call session control function (P-CSCF) inserts a flag into the mobile terminated (MT) session invite sent to the UE, which identifies the return call as being an emergency call. The access and mobility management function (AMF, or mobility management entity, MME) recognizes this flag and inserts another flag into a paging message for the UE (if the UE is in idle mode), or a session modification message for the UE (if the UE is in connected mode). The UE then inserts yet another flag into a session request message when answering the MT call from the PSAP. The wireless network recognizes this final flag and connects the UE to the PSAP using the SOS APN instead of the IMS APN.

Aspects of the disclosure improve the performance of wireless communications during emergencies, by handling return phone calls from PSAPs as emergency calls, with faster connection and higher priority than normal phone calls as a result of passing the return phone call through the SOS APN, rather than the IMS APN. Although examples are described primarily for cellular networks, the inventive concepts described herein extend to wireless communications in general. The advantageous operations are accomplished, at least in part, by the P-CSCF inserting a flag into the MT session invite that identifies the call from the PSAP as an emergency call, the mobility node (AMF or MME) inserting a flag into the paging or session modification message for the UE, and the UE inserting a flag into a session request message when answering the call from the PSAP.

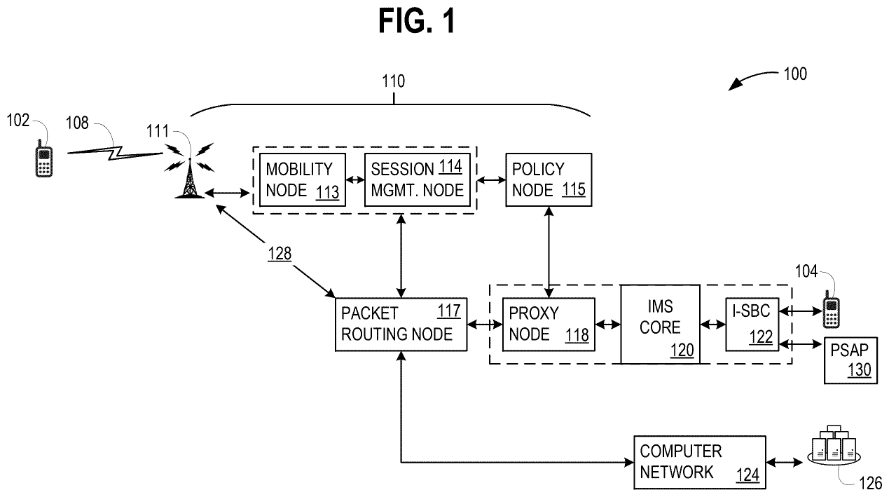

With reference now to the figures, FIG. 1 illustrates an exemplary architecture 100 that advantageously provides signaling, paging, and session modification enhancement for MT emergency calls. A wireless network 110 is illustrated that is serving a UE 102. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 104. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, a policy node 115, and other components (not shown). Wireless network 110 also has a packet routing node 117 and a proxy node 118. Mobility node 113, session management node 114, and policy node 115 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and also proxy node 118 via policy node 115. Packet routing node 117 is in communication with proxy node 118 and computer network 124.

In some 5G examples, base station 111 comprises a gNodeB (gNB), mobility node 113 comprises an AMF, session management node 114 comprises a session management function (SMF), policy node 115 comprises a policy control function (PCF), and packet routing node 117 comprises a user plane function (UPF). In some 4G examples, base station 111 comprises an eNodeB (eNB), mobility node 113 comprises an MME, session management node 114 comprises a system architecture evolution gateway (SAEGW) control plane (SAEGW-C), policy node 115 comprises a policy and charging rules function (PCRF), and packet routing node 117 comprises an SAEGW-user plane (SAEGW-U). In some examples, proxy node 118 comprises a P-CSCF in both 4G and 5G.

Proxy node 118 is in communication with an IMS core 120, which uses an access gateway (IMS-AGW) in order to provide connectivity to other wireless (cellular) networks, such as for a call with UE 104 or a public switched telephone system (PSTN, also known as plain old telephone system, POTS). In some examples, proxy node 118 may be considered to be within the IMS. UE 102 reaches network resource 126 using computer network 124 (or IMS core 120, in some examples). Data packets of data traffic 128 to/from UE 102 pass through at least base station 111 and packet routing node 117 on their way from/to computer network 124 or IMS core 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, when an emergency call answering point 130 (shown as a PSAP) calls UE 102, possibly using a PSTN, the call passes through an interconnect session border controller (I-SBC) 122 and IMS core 120 to reach wireless network 110, and then UE 102. This is an MT call, because it is incoming to UE 102. Proxy node 118, mobility node 113, and UE 102 each has new functionality to flag this MT call as an emergency call. Although FIG. 1 and some of the following figures are described using an example of a cellular network, it should be understood that the teachings herein are applicable to other types of wireless networks. To benefit from the teachings herein, another wireless network, other than a cellular network, should employ a special node that has a role in connecting distant end terminals and has a role that is equivalent to that of the SOS APN with regard to connection and routing. With such features, another type of wireless network, other than a cellular network, may also benefit from the disclosure herein.

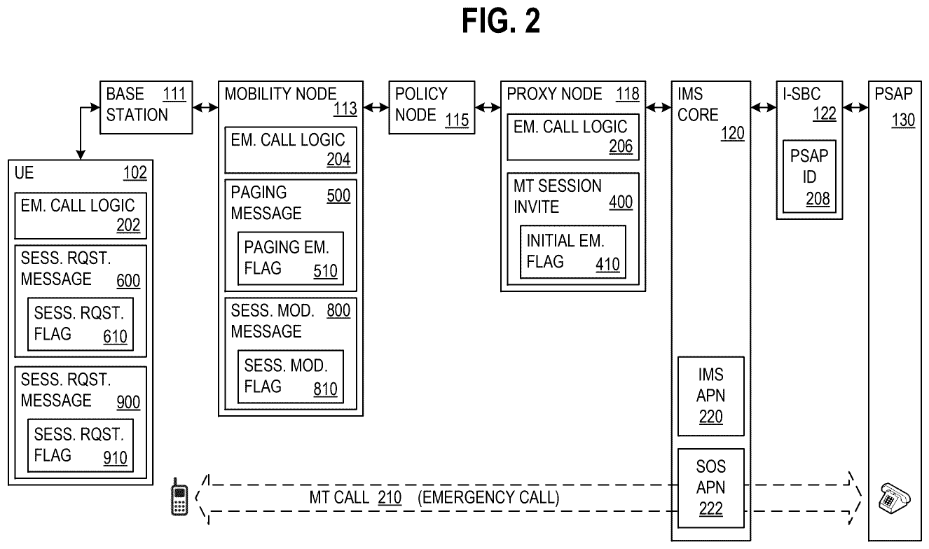

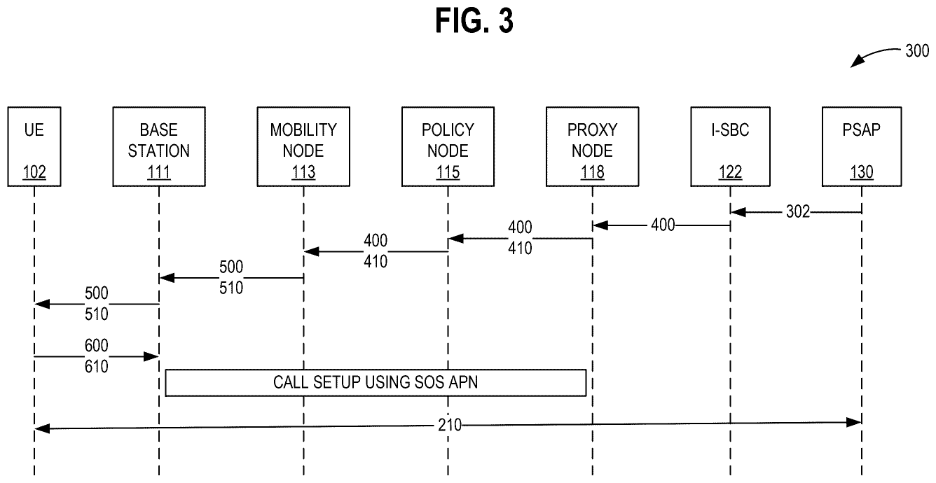

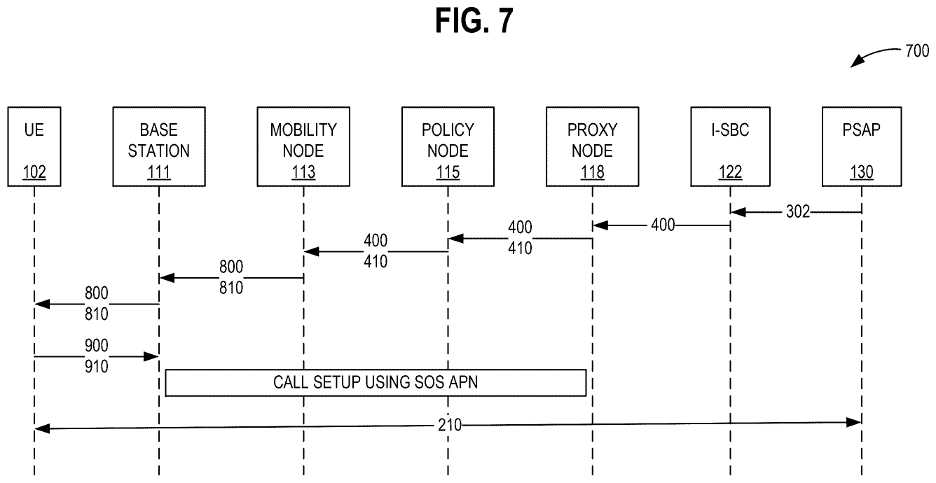

FIG. 2 illustrates features of the signaling enhancement of the architecture of FIG. 1 and is explained along with FIG. 3, for scenarios in which UE 102 is in idle mode when emergency call answering point 130 calls, and FIG. 7, for scenarios in which UE 102 is in connected mode when emergency call answering point 130 calls. FIG. 3 shows a message sequence diagram 300 of messages that start with an incoming call 302 from emergency call answering point 130 and concludes with an MT call 210 between UE 102 and emergency call answering point 130.

Message sequence diagram 300 begins with incoming call 302 from emergency call answering point 130, which is received by I-SBC 122. I-SBC 122 has PSAP identification (ID) logic 208 that identifies an IP address of emergency call answering point 130 associated with the signaling for MT call 210, or a phone number of emergency call answering point 130 provided through a PSTN (e.g., caller ID). PSAP ID logic 208 has a look-up table that identifies emergency call answering point 130 as being associated with the IP address or phone number. I-SBC 122 generates an MT session invite 400 and transmits it through IMS core 120 to proxy node 118. IMS core 120 has an IMS APN 220 that is used for normal phone calls and an SOS APN 222 that is used for emergency calls. As described previously, using SOS APN 222 provides advantages for emergency calls over using IMS APN 220.

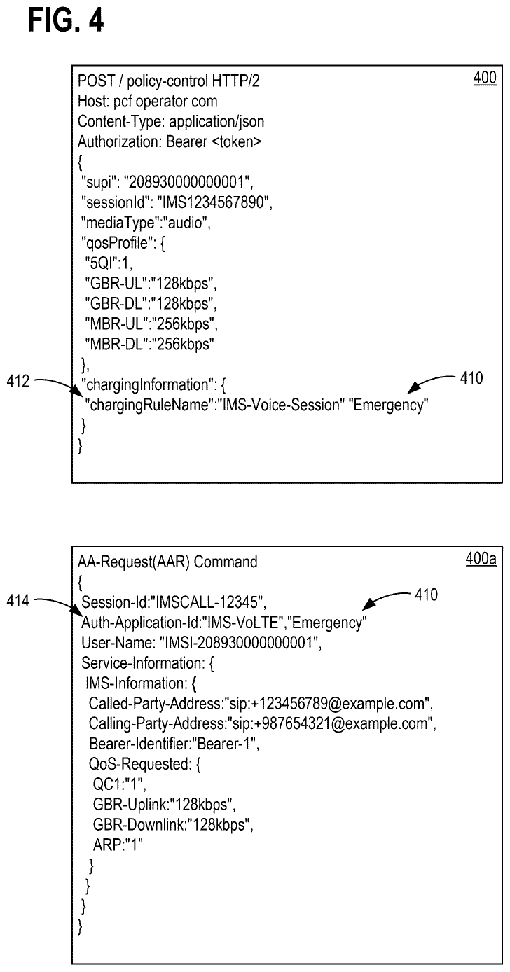

In some examples, MT session invite 400 comprises a session invitation protocol (SIP) message. Turning briefly to FIG. 4, which shows details for an example of MT session invite 400, both a 5G version (MT session invite 400) and a 4G version (MT session invite 400a) are shown. MT session invite 400 (the 5G version) has a chargingRuleName field 412 that holds “IMS-Voice-Session”, and an initial emergency call flag 410, shown as “Emergency” is added into chargingRuleName field 412 after “IMS-Voice-Session”. For the 4G version, MT session invite 400a has an Auth-Application-Id field 414 that holds “IMS-VoLTE”, and an initial emergency call flag 410, shown as “Emergency” is added into chargingRuleName field 412 after “IMS-VoLTE”.

In these specific 5G and 4G examples, when I-SBC 122 transmits MT session invite 400 (or MT session invite 400a, for 4G) through IMS core 120, to proxy node 118, MT session invite 400 does not yet have initial emergency call flag 410. Rather, initial emergency call flag 410 is injected by proxy node 118. It should be understood that other indications, other than “Emergency”, may be used as initial emergency call flag 410, and also that initial emergency call flag 410 may be located elsewhere within MT session invite 400 (or MT session invite 400a, for 4G).

Returning to FIGS. 2 and 3, proxy node 118 has emergency call handling logic 206 that adds initial emergency call flag 410 into MT session invite 400. Proxy node 118 forwards the enhanced MT session invite 400 to mobility node 113 via policy node 115. Mobility node 113 has emergency call handling logic 204 that recognizes initial emergency call flag 410 in MT session invite 400. Because, in this scenario, UE 102 is in idle mode, mobility node 113 generates a paging message 500 for the incoming call from emergency call answering point 130, and emergency call handling logic 204 injects a paging emergency call flag 510 into paging message 500.

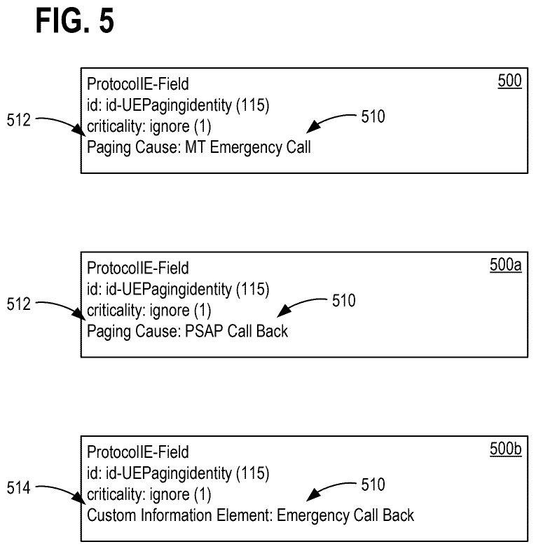

Turning briefly to FIG. 5, three examples of paging message 500 are shown. The first example of paging message 500 has a Paging Cause field 512 that holds “MT Emergency Call” as an example of paging emergency call flag 510. Another example, shown as paging message 500a, has “PSAP Call Back” an example of paging emergency call flag 510 in Paging Cause field 512. The third example, shown as paging message 500b, has an Information Element field 514 that holds “Emergency Call Back” an example of paging emergency call flag 510. It should be understood that other indications, other than those shown, may be used as paging emergency call flag 510, and also that paging emergency call flag 510 may be located elsewhere within paging message 500.

Returning to FIGS. 2 and 3, mobility node 113 sends paging message 500 to base station 111, which transmits paging message 500 to UE 102. UE 102 has emergency call handling logic 202 that recognizes paging emergency call flag 510 in paging message 500. To answer the incoming call from emergency call answering point 130, UE 102 generates a session request message 600, which may be a radio resource control (RRC) establishment with cause message in this scenario.

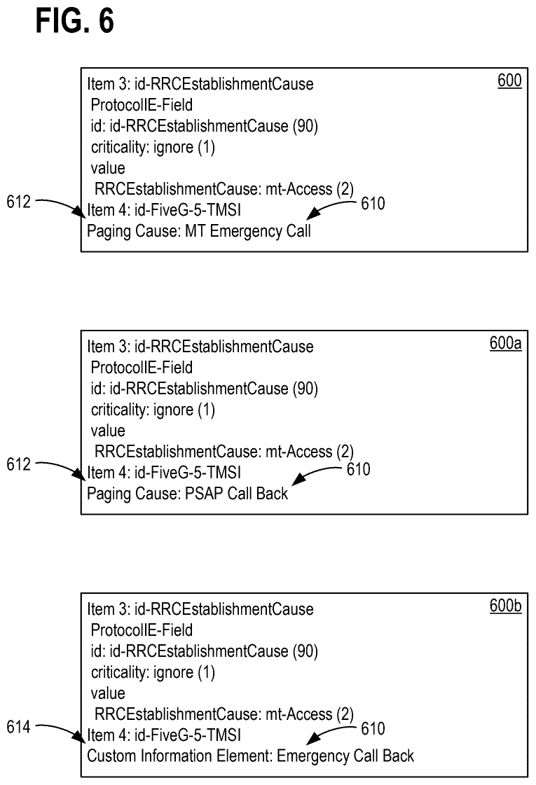

Turning briefly to FIG. 6, three examples of session request message 600 are shown. The first example of session request message 600 has an RRC Cause field 612 that holds “MT Emergency Call” as an example of session request emergency call flag 610. Another example, shown as session request message 600a, has “PSAP Call Back” as an example of session request emergency call flag 610 in RRC Cause field 612. The third example, shown as session request message 600a, has an Information Element field 614 that holds “Emergency Call Back” an example of session request emergency call flag 610. It should be understood that other indications, other than those shown, may be used as session request emergency call flag 610, and also that session request emergency call flag 610 may be located elsewhere within session request message 600.

Returning to FIGS. 2 and 3, UE 102 transmits session request message 600 to wireless network 110, via base station 111. Wireless network 110 sets up MT call 210 between UE 102 and emergency call answering point 130 using SOS APN 222, rather than IMS APN 220, because session request message 600 has session request emergency call flag 610.

FIG. 7 similarly shows a message sequence diagram 700 of messages that start with an incoming call 302 from emergency call answering point 130 and concludes with an MT call 210 between UE 102 and emergency call answering point 130. However, message sequence diagram 700 is for scenarios in which UE 102 is in connected mode when emergency call answering point 130 calls. Message sequence diagram 700 is the same as message sequence diagram 300, up through mobility node 113 receiving MT session invite 400 with initial emergency call flag 410. FIG. 7 should also be viewed along with FIG. 2.

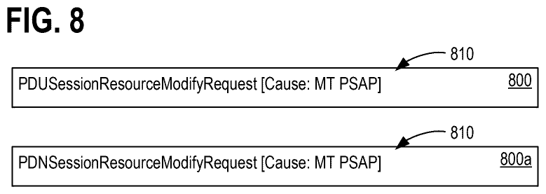

Because UE 102 is in connected mode, mobility node 113 generates a session modification message 800 for the incoming call from emergency call answering point 130, and emergency call handling logic 204 injects a session modification emergency call flag 810 into session modification message 800. Turning briefly to FIG. 8, two examples of session modification message 800 are shown. The first example of session modification message 800 is for 5G, and comprises a PDU session modification request and has “MT PSAP” as an example of session modification emergency call flag 810. Another example, which is for 4G, shown as session modification message 800a, comprises a packet data network (PDN) session modification request and also has “MT PSAP” as an example of session modification emergency call flag 810. It should be understood that other indications, other than those shown, may be used as session modification emergency call flag 810, and also that session modification emergency call flag 810 may be located elsewhere within session modification message 800.

Returning to FIGS. 2 and 7, mobility node 113 sends session modification message 800 to base station 111, which transmits session modification message 800 to UE 102. Emergency call handling logic 202, in UE 102, recognizes session modification emergency call flag 810 in session modification message 800. To answer the incoming call from emergency call answering point 130, UE 102 generates a session request message 900, which may be a PDU session modification response for 5G or a PDN session modification response for 4G, in this scenario.

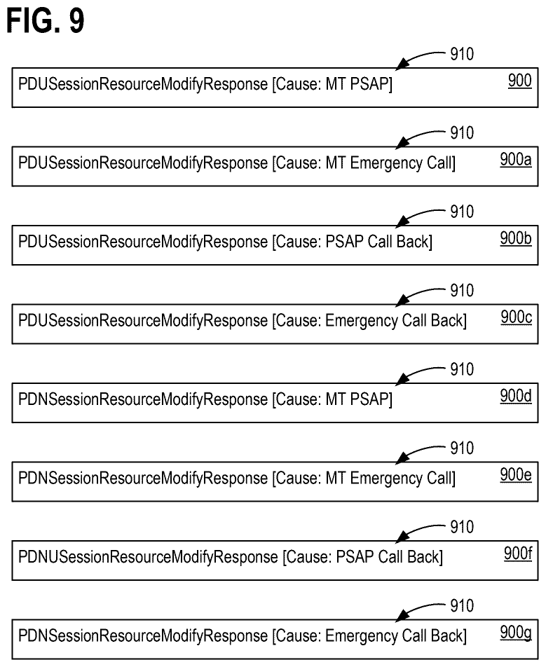

Turning briefly to FIG. 9, eight examples of session request message 900 are shown. The first example of session request message 900 is for 5G, and has “MT PSAP” as an example of session request emergency call flag 910. Another 5G example, shown as session request message 900a, has “MT Emergency Call” as an example of session request emergency call flag 910. The third 5G example, shown as session request message 900b, has “PSAP Call Back” as an example of session request emergency call flag 910. The fourth 5G example, shown as session request message 900c, has “Emergency Call Back” as an example of session request emergency call flag 910. A 4G example, shown as session request message 900d, has “MT PSAP” as an example of session request emergency call flag 910. Another 4G example, shown as session request message 900e, has “MT Emergency Call” as an example of session request emergency call flag 910. The third 4G example, shown as session request message 900f, has “PSAP Call Back” as an example of session request emergency call flag 910. The fourth 4G example, shown as session request message 900g, has “Emergency Call Back” as an example of session request emergency call flag 910. It should be understood that other indications, other than those shown, may be used as session request emergency call flag 910, and also that session request emergency call flag 910 may be located elsewhere within session request message 900.

Returning to FIGS. 2 and 7, UE 102 transmits session request message 900 to wireless network 110, via base station 111. Wireless network 110 sets up MT call 210 between UE 102 and emergency call answering point 130 using SOS APN 222, rather than IMS APN 220, because session request message 900 has session request emergency call flag 910.

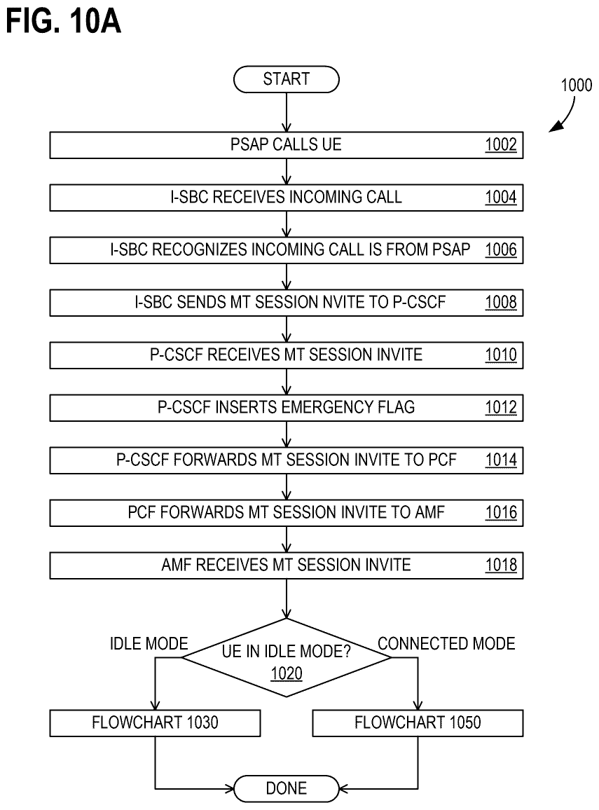

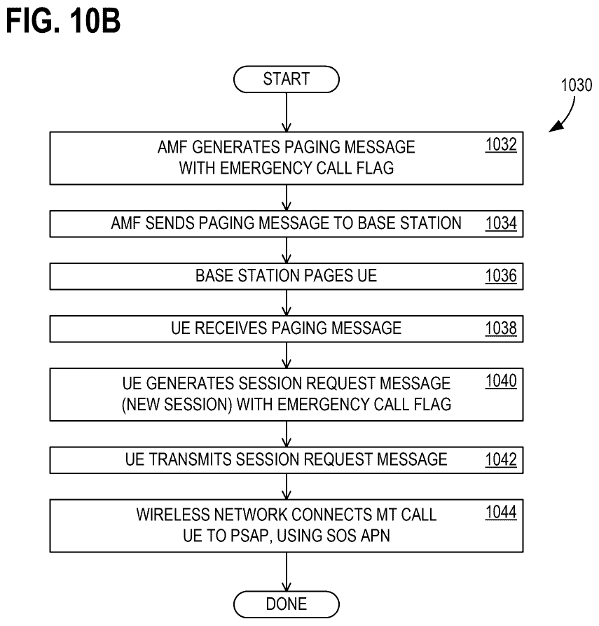

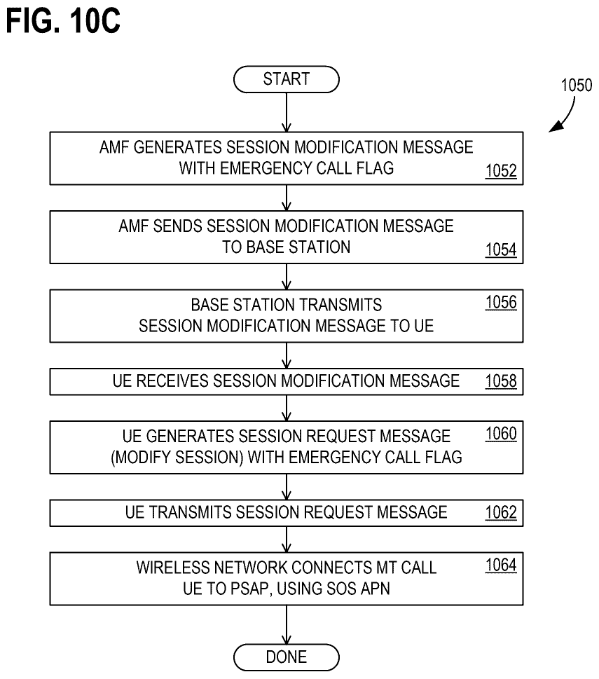

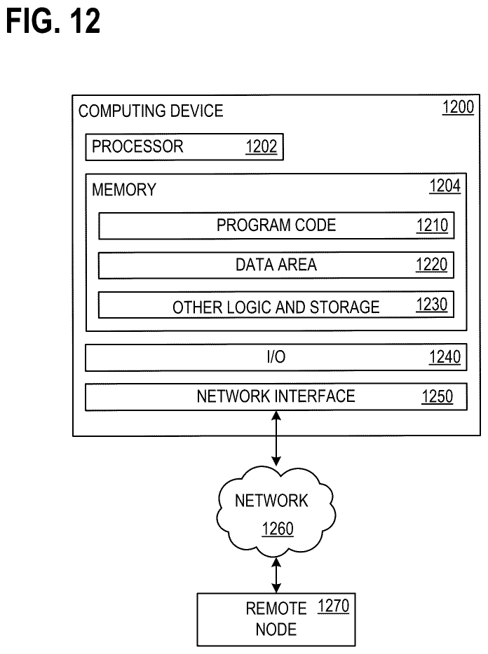

FIGS. 10A, 10B, and 10C illustrate flowcharts 1000, 1030, and 1050, respectively, of exemplary operations associated with examples of architecture 100. In some examples, at least a portion of flowcharts 1000, 1030, and 1050 may be performed using one or more computing devices 1200 of FIG. 12. Flowchart 1000 commences with emergency call answering point 130 calling UE 102 in operation 1002, creating incoming call 302. I-SBC 122 receives incoming call 302 from emergency call answering point 130 in operation 1004.

In operation 1006, I-SBC 122 associates incoming call 302 with emergency call answering point 130, using PSAP ID logic 208, and indicates that MT session invite 400 is associated with emergency call answering point 130. I-SBC 122 transmits MT session invite 400 (for UE 102) to proxy node 118 in operation 1008. Proxy node 118 receives MT session invite 400 from emergency call answering point 130 in operation 1010. At this point, MT session invite 400 does not yet have initial emergency call flag 410.

Proxy node 118 inserts initial emergency call flag 410 into MT session invite 400 in operation 1012. In some examples, initial emergency call flag 410 is inserted into chargingRuleName field 412 of MT session invite 400 or Auth-Application-Id field 414 of MT session invite 400. In some examples, initial emergency call flag 410 comprises “Emergency” added after “IMS-Voice-Session” or “IMS-VoLTE”. Proxy node 118 then forwards MT session invite 400 (with initial emergency call flag 410) to policy node 115 in operation 1014. Policy node 115 receives MT session invite 400 and forwards MT session invite 400 mobility node 113 in operation 1016.

In operation 1018, mobility node 113 receives MT session invite 400, which now has initial emergency call flag 410, from policy node 115. Decision operation 1020 determines whether UE 102 is in idle mode or connected mode. In some examples, this is performed by mobility node 113. If UE 102 is in idle mode, flowchart 1000 moves to flowchart 1030. If UE 102 is in connected mode, flowchart 1000 moves to flowchart 1050.

Turning now to FIG. 10B, flowchart 1030 is described for scenarios in which UE 102 is in idle mode. Based on at least mobility node 113 identifying initial emergency call flag 410 in MT session invite 400, and further based on at least identifying that UE 102 is in idle mode, mobility node 113 generates paging message 500 for UE 102 in operation 1032.

Paging message 500 indicates MT call 212 from emergency call answering point 130 and contains paging emergency call flag 510. In some examples, paging emergency call flag 510 is inserted into Paging Cause field 512 of paging message 500 or Information Element field 514 of paging message 500. In some examples, paging emergency call flag 510 comprises “MT Emergency Call”, “PSAP Call Back”, or “Emergency Call Back”. In operation 1034, mobility node 113 forwards paging message 500, with paging emergency call flag 510, to base station 111, and base station 111 pages UE 102 using paging message 500 in operation 1036.

UE 102 receives paging message 500 from base station 111 in operation 1038. Based on at least receiving paging message 500, UE 102 generates session request message 600 in operation 1040. Session request message 600 indicates MT call 212 and contains session request emergency call flag 610. In some examples, session request message 600 comprises an RRC establishment with cause message. In some examples, session request emergency call flag 610 is inserted into RRC Cause field 612 of session request message 600 or Information Element field 614 of session request message 600. In some examples, session request emergency call flag 610 comprises “MT Emergency Call”, “PSAP Call Back”, “MT PSAP”, or “Emergency Call Back”.

UE 102 transmits session request message 600, with session request emergency call flag 610, to base station 111 in operation 1042. In operation 1044, wireless network 110 receives session request message 600 (via base station 111) and connects MT call 212, for UE 102, with emergency call answering point 130. Based on at least session request message 600 containing session request emergency call flag 610, wireless network 110 uses SOS APN 222 for MT call 212, between emergency call answering point 130 and UE 102, rather than using IMS APN 220.

Turning now to FIG. 10B, flowchart 1030 is described for scenarios in which UE 102 is in connected mode. Based on at least mobility node 113 identifying initial emergency call flag 410 in MT session invite 400, and further based on at least identifying that UE 102 is in connected mode, mobility node 113 generates session modification message 800 for UE 102 in operation 1052.

Session modification message 800 indicates MT call 212 from emergency call answering point 130 and contains session modification emergency call flag 810. In some examples, session modification message 800 comprises a PDU modification with cause message. In some examples, session modification emergency call flag 810 comprises “MT PSAP”. In operation 1054, mobility node 113 forwards session modification message 800, with session modification emergency call flag 810, to base station 111, and base station 111 transmits session modification message 800 to UE 102 in operation 1056.

UE 102 receives session modification message 800 from base station 111 in operation 1058. Based on at least receiving session modification message 800, UE 102 generates session request message 900 in operation 1060. Session request message 900 indicates MT call 212 and contains session request emergency call flag 910. In some examples, session request message 900 comprises a PDU session modification response or a PDN session modification response. In some examples, session request emergency call flag 910 comprises “MT Emergency Call”, “PSAP Call Back”, “MT PSAP”, or “Emergency Call Back”.

UE 102 transmits session request message 900, with session request emergency call flag 910, to base station 111 in operation 1062. In operation 1064, wireless network 110 receives session request message 900 (via base station 111) and connects MT call 212, for UE 102, with emergency call answering point 130. Based on at least session request message 900 containing session request emergency call flag 910, wireless network 110 uses SOS APN 222 for MT call 212, between emergency call answering point 130 and UE 102, rather than using IMS APN 220.

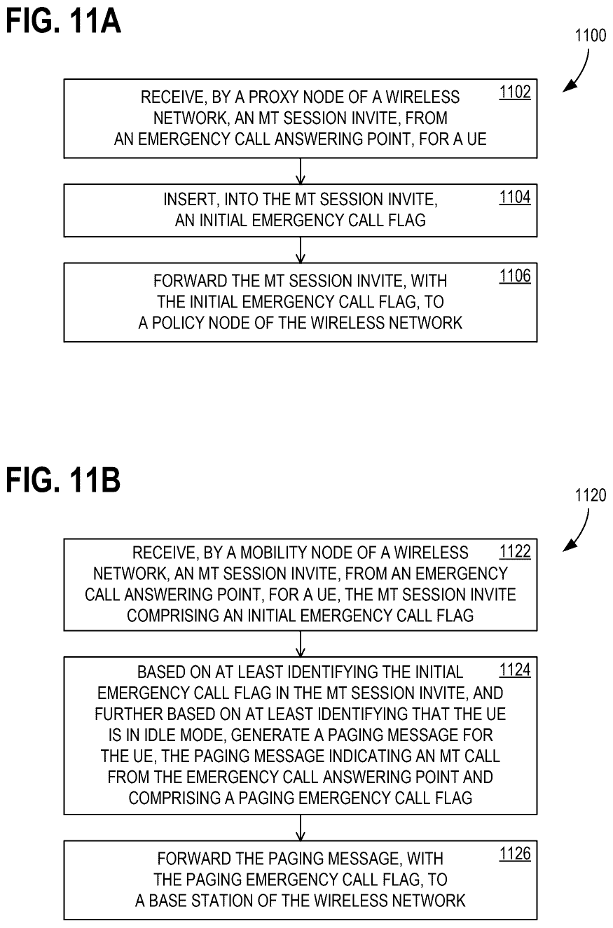

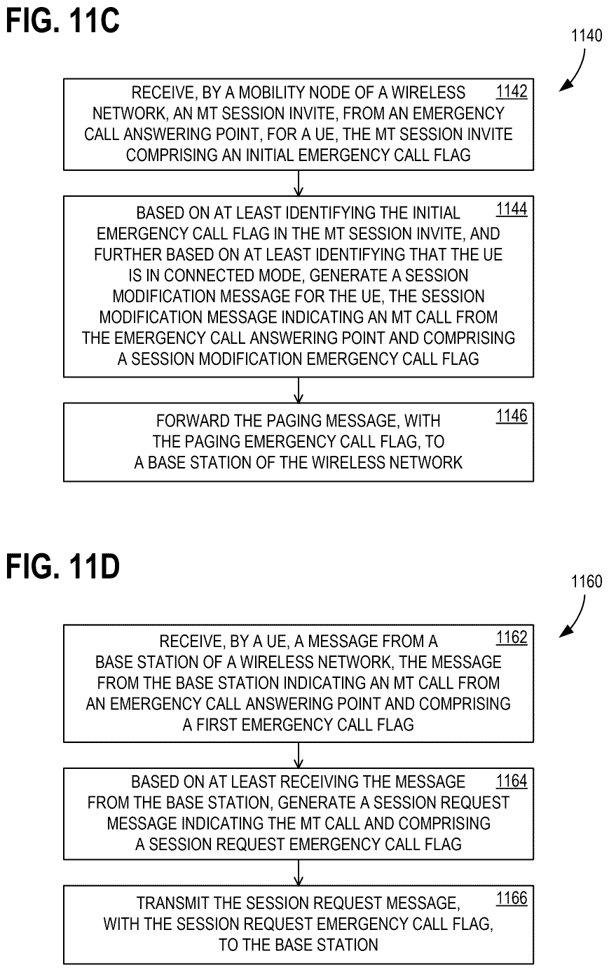

FIG. 11A illustrates a flowchart 1100 of exemplary operations associated with architecture 100. In some examples, at least a portion of flowchart 1100 may be performed using one or more computing devices 1200 of FIG. 12. Flowchart 1100 commences with operation 1102, which includes receiving, by a proxy node of a wireless network, an MT session invite, from an emergency call answering point, for a UE. Operation 1104 includes inserting, into the MT session invite, an initial emergency call flag. Operation 1106 includes forwarding the MT session invite, with the initial emergency call flag, to a policy node of the wireless network.

FIG. 11B illustrates a flowchart 1120 of exemplary operations associated with architecture 100. In some examples, at least a portion of flowchart 1120 may be performed using one or more computing devices 1200 of FIG. 12. Flowchart 1120 commences with operation 1122, which includes receiving, by a mobility node of a wireless network, an MT session invite, from an emergency call answering point, for a UE, the MT session invite comprising an initial emergency call flag.

Operation 1124 includes, based on at least identifying the initial emergency call flag in the MT session invite, and further based on at least identifying that the UE is in idle mode, generating a paging message for the UE, the paging message indicating an MT call from the emergency call answering point and comprising a paging emergency call flag. Operation 1126 includes forwarding the paging message, with the paging emergency call flag, to a base station of the wireless network.

FIG. 11C illustrates a flowchart 1140 of exemplary operations associated with architecture 100. In some examples, at least a portion of flowchart 1140 may be performed using one or more computing devices 1200 of FIG. 12. Flowchart 1140 commences with operation 1142, which includes receiving, by a mobility node of a wireless network, an MT session invite, from an emergency call answering point, for a UE, the MT session invite comprising an initial emergency call flag.

Operation 1144 includes, based on at least identifying the initial emergency call flag in the MT session invite, and further based on at least identifying that the UE is in connected mode, generating a session modification message for the UE, the session modification message indicating an MT call from the emergency call answering point and comprising a session modification emergency call flag. Operation 1146 includes forwarding the session modification message, with the session modification emergency call flag, to a base station of the wireless network.

FIG. 11D illustrates a flowchart 1160 of exemplary operations associated with architecture 100. In some examples, at least a portion of flowchart 1160 may be performed using one or more computing devices 1200 of FIG. 12. Flowchart 1160 commences with operation 1162, which includes receiving, by a UE, a message from a base station of a wireless network, the message from the base station indicating an MT call from an emergency call answering point and comprising a first emergency call flag.

Operation 1164 includes, based on at least receiving the message from the base station, generating a session request message indicating the MT call and comprising a session request emergency call flag. Operation 1166 includes transmitting the session request message, with the session request emergency call flag, to the base station.

FIG. 12 illustrates a block diagram of computing device 1200 that may be used as any component described herein that may require computational or storage capacity. Computing device 1200 has at least a processor 1202 and a memory 1204 that holds program code 1210, data area 1220, and other logic and storage 1230. Memory 1204 is any device allowing information, such as computer executable instructions and/or other data, to be stored and retrieved. For example, memory 1204 may include one or more random access memory (RAM) modules, flash memory modules, hard disks, solid-state disks, persistent memory devices, and/or optical disks. Program code 1210 comprises computer executable instructions and computer executable components including instructions used to perform operations described herein. Data area 1220 holds data used to perform operations described herein. Memory 1204 also includes other logic and storage 1230 that performs or facilitates other functions disclosed herein or otherwise required of computing device 1200. An input/output (I/O) component 1240 facilitates receiving input from users and other devices and generating displays for users and outputs for other devices. A network interface 1250 permits communication over external computer network 1260 (e.g., computer network 124) with a remote node 1270, which may represent another implementation of computing device 1200. For example, a remote node 1270 may represent another of the above-noted nodes within architecture 100.

### Additional Examples

An example system comprises: a processor; and a computer-readable medium storing instructions that are operative upon execution by the processor to: receive, by a proxy node of a wireless network, an MT session invite, from an emergency call answering point, for a UE; insert, into the MT session invite, an initial emergency call flag; and forward the MT session invite, with the initial emergency call flag, to a policy node of the wireless network.

Another example system comprises: a processor; and a computer-readable medium storing instructions that are operative upon execution by the processor to: receive, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in idle mode, generate a paging message for the UE, the paging message indicating an MT call from the emergency call answering point and comprising a paging emergency call flag; and forward the paging message, with the paging emergency call flag, to a base station of the wireless network.

Another example system comprises: a processor; and a computer-readable medium storing instructions that are operative upon execution by the processor to: receive, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in connected mode, generate a session modification message for the UE, the session modification message indicating an MT call from the emergency call answering point and comprising a session modification emergency call flag; and forward the session modification message, with the session modification emergency call flag, to a base station of the wireless network.

Another example system comprises: a processor; and a computer-readable medium storing instructions that are operative upon execution by the processor to: receive, by a UE, a message from a base station of a wireless network, the message from the base station indicating an MT call from an emergency call answering point and comprising a first emergency call flag; based on at least receiving the message from the base station, generate a session request message indicating the MT call and comprising a session request emergency call flag; and transmit the session request message, with the session request emergency call flag, to the base station.

An example method of wireless communication comprises: receiving, by a proxy node of a wireless network, an MT session invite, from an emergency call answering point, for a UE; inserting, into the MT session invite, an initial emergency call flag; and forwarding the MT session invite, with the initial emergency call flag, to a policy node of the wireless network.

Another example method of wireless communication comprises: receiving, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in idle mode, generating a paging message for the UE, the paging message indicating an MT call from the emergency call answering point and comprising a paging emergency call flag; and forwarding the paging message, with the paging emergency call flag, to a base station of the wireless network.

Another example method of wireless communication comprises: receiving, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in connected mode, generating a session modification message for the UE, the session modification message indicating an MT call from the emergency call answering point and comprising a session modification emergency call flag; and forwarding the session modification message, with the session modification emergency call flag, to a base station of the wireless network.

Another example method of wireless communication comprises: receiving, by a UE, a message from a base station of a wireless network, the message from the base station indicating an MT call from an emergency call answering point and comprising a first emergency call flag; based on at least receiving the message from the base station, generating a session request message indicating the MT call and comprising a session request emergency call flag; and transmitting the session request message, with the session request emergency call flag, to the base station.

One or more example computer storage devices has computer-executable instructions stored thereon, which, upon execution by a computer, cause the computer to perform operations comprising: receiving, by a proxy node of a wireless network, an MT session invite, from an emergency call answering point, for a UE; inserting, into the MT session invite, an initial emergency call flag; and forwarding the MT session invite, with the initial emergency call flag, to a policy node of the wireless network.

One or more example computer storage devices has computer-executable instructions stored thereon, which, upon execution by a computer, cause the computer to perform operations comprising: receiving, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in idle mode, generating a paging message for the UE, the paging message indicating an MT call from the emergency call answering point and comprising a paging emergency call flag; and forwarding the paging message, with the paging emergency call flag, to a base station of the wireless network.

One or more example computer storage devices has computer-executable instructions stored thereon, which, upon execution by a computer, cause the computer to perform operations comprising: receiving, by a mobility node of a wireless network, an MT session invite, from an emergency call answering point, for a UE, the MT session invite comprising an initial emergency call flag; based on at least identifying the initial emergency call flag in the MT session invite, and further based on at least identifying that the UE is in connected mode, generating a session modification message for the UE, the session modification message indicating an MT call from the emergency call answering point and comprising a session modification emergency call flag; and forwarding the session modification message, with the session modification emergency call flag, to a base station of the wireless network.

One or more example computer storage devices has computer-executable instructions stored thereon, which, upon execution by a computer, cause the computer to perform operations comprising: receiving, by a UE, a message from a base station of a wireless network, the message from the base station indicating an MT call from an emergency call answering point and comprising a first emergency call flag; based on at least receiving the message from the base station, generating a session request message indicating the MT call and comprising a session request emergency call flag; and transmitting the session request message, with the session request emergency call flag, to the base station.

Alternatively, or in addition to the other examples described herein, examples include any combination of the following:
the wireless network comprises a cellular network;
the UE comprises a cellular phone;
the base station comprises a gNB or an eNB;
the proxy node comprises a P-CSCF;
the emergency call answering point comprises a PSAP;
the MT session invite comprises a SIP message;
the policy node comprises a PCF or a PCRF;
the initial emergency call flag is inserted into a chargingRuleName field of the MT session invite or an Auth-Application-Id field of the MT session invite;
the initial emergency call flag comprises Emergency added after IMS-Voice-Session or IMS-VoLTE;
forwarding, by the policy node, the MT session invite to a mobility node of the wireless network;
receiving, by the mobility node, the MT session invite comprising the initial emergency call flag;
based on at least identifying the initial emergency call flag in the MT session invite, and further based on at least identifying that the UE is in idle mode, generating a paging message for the UE;
the paging message indicates an MT call and comprises a paging emergency call flag;
forwarding the paging message, with the paging emergency call flag, to a base station of the wireless network;
paging the UE, by the base station, using the paging message;
based on at least identifying the initial emergency call flag in the MT session invite, and further based on at least identifying that the UE is in connected mode, generating a session modification message for the UE;
the session modification message indicates an MT call and comprises a session modification emergency call flag;
forwarding the session modification message, with the session modification emergency call flag, to a base station of the wireless network;
transmitting, by the base station, the session modification message to the UE;
receiving, by the UE, a message from a base station of the wireless network;
the message from the base station indicates an MT call from the emergency call answering point and comprises a first emergency call flag;
the message from the base station comprises a paging message and the first emergency call flag comprises a paging emergency call flag;
the message from the base station comprises a session modification message and the first emergency call flag comprises a session modification emergency call flag;
based on at least receiving the message from the base station, generating a session request message indicating the MT call and comprising a session request emergency call flag;
transmitting the session request message, with the session request emergency call flag, to the base station;
connecting, by the wireless network, the MT call for the UE with the emergency call answering point, using an SOS APN, based on at least the session request emergency call flag;
the mobility node comprises an AMF or an MME;
the mobility node receives the MT session invite from a policy node of the wireless network;
the paging emergency call flag is inserted into a Paging Cause field of the paging message or an Information Element field of the paging message;
the paging emergency call flag comprises MT Emergency Call, or PSAP Call Back, or Emergency Call Back;
receiving, by the UE, the paging message from the base station;
based on at least receiving the paging message, generating a session request message indicating the MT call and comprising a session request emergency call flag;
prior to the mobility node receiving the MT session invite, receiving, by a proxy node of the wireless network, the MT session invite, without the initial emergency call flag, from the emergency call answering point;
the session modification message comprises a PDU modification with cause message;
the session modification emergency call flag comprises MT PSAP;
receiving, by the UE, the session modification message from the base station;
based on at least receiving the session modification message, generating a session request message indicating the MT call and comprising a session request emergency call flag;
receiving, by the base station, the session request message;
the session request emergency call flag is inserted into an RRC Cause field of the session request message or an Information Element field of the session request message;
the session request emergency call flag comprises MT Emergency Call, or PSAP Call Back, or MT PSAP, or Emergency Call Back; and
the session request message comprises a PDU session modification response, or a PDN session modification response, or an RRC establishment with cause message.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving, by a user equipment (UE), a message from a base station of a wireless network, the message from the base station indicating a mobile terminated (MT) call from an emergency call answering point and comprising a first emergency call flag;
based on at least receiving the message from the base station, generating a session request message indicating the MT call and comprising a session request emergency call flag; and
transmitting the session request message, with the session request emergency call flag, to the base station.

2. The method of claim 1, wherein the method further comprises:
receiving, by the base station, the session request message; and
connecting, by the wireless network, the MT call for the UE with the emergency call answering point, using an SOS access point name (APN), based on at least the session request emergency call flag.

3. The method of claim 1, wherein the session request emergency call flag is inserted into an RRC Cause field of the session request message or an Information Element field of the session request message.

4. The method of claim 1 wherein the session request emergency call flag comprises MT Emergency Call, or PSAP Call Back, or MT PSAP, or Emergency Call Back.

5. The method of claim 1, wherein the session request message comprises a protocol data unit (PDU) session modification response or a radio resource control (RRC) establishment with cause message.

6. The method of claim 1, wherein the emergency call answering point comprises a public safety answering point (PSAP).

7. The method of claim 1, wherein the message from the base station comprises a paging message and the first emergency call flag comprises a paging emergency call flag, or wherein the message from the base station comprises a session modification message and the first emergency call flag comprises a session modification emergency call flag.

8. The method of claim 7, wherein the paging emergency call flag is inserted into a Paging Cause field of the paging message or an Information Element field of the paging message.

9. The method of claim 7, wherein the paging emergency call flag comprises MT Emergency Call, or PSAP Call Back, or Emergency Call Back.

10. The method of claim 7, wherein the session modification message comprises a protocol data unit (PDU) modification with cause message.

11. The method of claim 7, wherein the session modification emergency call flag comprises MT PSAP.

12. A system comprising:
a processor; and
a computer-readable medium storing instructions that are operative upon execution by the processor to:
receive, by a user equipment (UE), a message from a base station of a wireless network, the message from the base station indicating a mobile terminated (MT) call from an emergency call answering point and comprising a first emergency call flag;
based on at least receiving the message from the base station, generate a session request message indicating the MT call and comprising a session request emergency call flag; and
transmit the session request message, with the session request emergency call flag, to the base station.

13. The system of claim 12, wherein the instructions are further operative to:
receive, by the base station, the session request message; and
connect, by the wireless network, the MT call for the UE with the emergency call answering point, using an SOS access point name (APN), based on at least the session request emergency call flag.

14. The system of claim 12,
wherein the session request emergency call flag is inserted into an RRC Cause field of the session request message or an Information Element field of the session request message;
wherein the session request emergency call flag comprises MT Emergency Call, or PSAP Call Back, or MT PSAP, or Emergency Call Back; or
wherein the session request message comprises a protocol data unit (PDU) session modification response or a radio resource control (RRC) establishment with cause message.

15. The system of claim 12, wherein the emergency call answering point comprises a public safety answering point (PSAP).

16. The system of claim 12, wherein the message from the base station comprises a paging message and the first emergency call flag comprises a paging emergency call flag, or wherein the message from the base station comprises a session modification message and the first emergency call flag comprises a session modification emergency call flag.

17. One or more computer storage devices having computer-executable instructions stored thereon, which, upon execution by a computer, cause the computer to perform operations comprising:
receiving, by a user equipment (UE), a message from a base station of a wireless network, the message from the base station indicating a mobile terminated (MT) call from an emergency call answering point and comprising a first emergency call flag;
based on at least receiving the message from the base station, generating a session request message indicating the MT call and comprising a session request emergency call flag; and
transmitting the session request message, with the session request emergency call flag, to the base station.

18. The one or more computer storage devices of claim 17, wherein the operations further comprise:
receiving, by the base station, the session request message; and
connecting, by the wireless network, the MT call for the UE with the emergency call answering point, using an SOS access point name (APN), based on at least the session request emergency call flag.

19. The one or more computer storage devices of claim 17,
wherein the session request emergency call flag is inserted into an RRC Cause field of the session request message or an Information Element field of the session request message;
wherein the session request emergency call flag comprises MT Emergency Call, or PSAP Call Back, or MT PSAP, or Emergency Call Back; or
wherein the session request message comprises a protocol data unit (PDU) session modification response or a radio resource control (RRC) establishment with cause message.

20. The one or more computer storage devices of claim 17, wherein the message from the base station comprises a paging message and the first emergency call flag comprises a paging emergency call flag, or wherein the message from the base station comprises a session modification message and the first emergency call flag comprises a session modification emergency call flag.
